(19) United States
(12) Patent Application Publication
(10) Pub. No.: US 2013/0114133 A1
(43) Pub. Date: May 9, 2013

(54) THIN FILMS FOR ENERGY EFFICIENT TRANSPARENT ELECTROMAGNETIC SHIELDS

(71) Applicants: Maria Sabrina Sarto, Roma (IT); Francesca Sarto, Roma (IT); Domenico Alessandro Lampasi, Roma (IT); Alessio Tamburrano, Roma (IT); Marcello D'Amore, Roma (IT)

(72) Inventors: Maria Sabrina Sarto, Roma (IT); Francesca Sarto, Roma (IT); Domenico Alessandro Lampasi, Roma (IT); Alessio Tamburrano, Roma (IT); Marcello D'Amore, Roma (IT)

(73) Assignee: UNIVERSITA DEGLI STUDI DL ROMA "LA SAPIENZA'', Roma (IT)

(21) Appl. No.: 13/809,919

(22) PCT Filed: Jul. 12, 2011
(86) PCT No.: PCT/IT2011/000242

§ 371 Date: Jan. 14, 2013

(30) Foreign Application Priority Data
Jul. 12, 2010 (IT) RM2010A000380

(51) Int. Cl. G02B 5/20

(52) U.S. Cl. CPC G02B 5/208
USPC 359/360; 977/902

(57) ABSTRACT

Multifunctional, radio frequency shielding, transparent in the visible and energy saving film, including an asymmetric and aperiodic superposition of three dielectric or semiconductor (D) layers alternated to two metal (M) nanometric layers, wherein the ratio of the thickness of the outermost metal layer to the inner one is between 1.4 and 1.7. Such a film can be applied on a transparent substrate to make a frequency selective screen having solar absorbance (Aₑ) always lower than 17% and one of the following combination of performances:

Shielding effectiveness (SE) higher than 32 dB from 30 kHz to 18 GHz, with optical visible transmittance (Tᵥ) higher than 75%;

Shielding effectiveness higher (SE) than 36 dB from 30 kHz to 18 GHz, with optical visible transmittance (Tᵥ) higher than 65%;

Shielding effectiveness (SE) higher than 38 dB from 30 kHz to 18 GHz, with optical visible transmittance (Tᵥ) higher than 50%.

### TECHNICAL FIELD

The present invention relates to the manufacturing of a radio frequency (RF) passive electromagnetic screen (EM), preferably for the band comprised between 30 kHz and 18 GHz, being transparent in the visible, low-emitting, and/or solar-controlled.

More particularly, the invention relates to a thin film shielding to radiofrequencies for the manufacturing of a screen transparent in the visible and able to contribute to energy efficiency, for example in the construction field and in the field of transport vehicles.

### STATE OF THE ART

As is known, the civil and industrial construction field accounts for about one third of national energy consumption.

The main cause of energy consumption and environmental impact in the construction field is due to air-conditioned building.

Therefore, the reduction of energy demand for cooling and heating can be achieved by means of optimized plant engineering and construction systems, and among them the choice of the type of glass to be applied to windows in order to control heat flow between inside and outside and vice versa.

Only with reference to energy and heat exchange issues between the interior and exterior part of a building, two types of films applied to windows of buildings are currently known:

i) low-emissivity films (applied on the inner surface of the glass), which block the infrared radiation emitted by the heating radiators of the heating system, improving the performances of double glazing and reducing thermal losses from 25 to 35%;

ii) solar-control films that reflect infrared solar radiation, significantly reducing the heat entering the air-conditioned areas.

The definition of “solar radiation” that is meant in the present application is that usually intended in the field of energy saving and efficient windows and it is as following:

Solar radiation is the radiant energy emitted by the sun, i.e. the energy transported by the electromagnetic waves (photons) that is produced by the sun and travels through the atmosphere to the Earth's surface.

Following this definition, the physical observable associated to solar radiation is the irradiance, that is a measure of how much solar energy you are getting at your location per unit time and unit surface; in the SI the irradiance is measured in watt per square meter. The spectral distribution of solar radiation, (otherwise said “solar spectrum”) is the solar irradiance per wavelength unit interval, i.e., the energy per unit time and unit surface transported by an electromagnetic wave having wavelength in the interval (λ−δλ/2, λ+δλ/2), where δλ is the wavelength accuracy. The solar spectrum changes throughout the day and with location. Standard reference spectra are defined to allow the performance comparison of devices (such as the present invention). In the present application reference is made to the ISO 9845 reference spectrum.

It is also known that low-emissivity and/or solar-control films easily applicable on glass-window surfaces are increasingly used to improve thermal insulation, reduce air conditioning costs, ensure better environmental comfort, due to the reduction of light reflections and glares.

Although the films for energy efficiency of a known type are very common, their behavior towards the RF electromagnetic waves has not been normally investigated by the producers and therefore not optimized in order to achieve satisfactory shielding performances.

In this connection, it should be considered that the glass surfaces are a critical area not only in terms of energy, but also from the electromagnetic point of view since they are generally transparent to radio frequencies and are therefore the preferential route for the penetration of the electromagnetic field into a building.

A first drawback is that in such circumstances, when in the presence of external sources issuers, such as radio base stations or radio and TV relay stations, values of electromagnetic field which prove to be critical for human exposure may occur inside the building.

A second drawback is related to the EM fields generated by sources located inside a building, which being transmitted outside through unscreened windows can also cause problems for the proper functioning of electrical and electronic devices operating in close proximity. For example, the increasing use of wireless devices in homes, offices and buildings used for commercial activities often causes electromagnetic interferences on car remote controls or electronic devices used to control or remotely control a machine.

The RF electromagnetic field incident on a building or generated from sources from within experiences an attenuation, which depends on many factors; the presence of windows is the main cause contributing to the transmission of the field both from the outside towards the inside of a building, and from the inside towards the outside.

To solve this problem, the radio frequency electromagnetic shielding is generally achieved by the use of screens containing conductive components, such as wire mesh, material loaded with conductive powders or thin films of tin-doped indium oxide (ITO). However, metals are good shielding materials for not only radio frequency but also in the visible band, and have a high absorption coefficient of electromagnetic radiation in the infrared.

Electromagnetic shields for radio frequency, which also have high transparency in the visible, have been developed using thin multilayer metal/dielectric film technology.

They are generally constituted by the repetition of a symmetrical structure comprising a thin metallic layer, responsible for electrical conduction, sandwiched between two layers of dielectric material in order to reduce the reflectance in the visible. The structure is repeated one or more times as long as the total thickness of metal is sufficient to ensure the electrical conduction required to obtain the desired RF shielding and the transmittance in the visible does not drop more than a desired minimum. Typical values of the total thickness of the metal, for example in relation to silver, are between 20 nm and 66 nm for values of shielding effectiveness, interesting for electromagnetic applications, ranging from approximately 30 dB and 40 dB, and the average visible transmittance between 50% and 70%. In particular, the higher is transmittance in the visible, the lower is the thickness of individual layers in which the total thickness of metal necessary to ensure the provision of RF electromagnetic is split.

The same technology can be used for the manufacturing of low-emissivity coatings that can reflect the infrared radiation. In this case, however, the total thickness of metal used is typically less than that required for RF shielding applications with the same optical transmittance in the visible. In contrast, low-emissivity and solar-control performances of the coatings optimized for RF shielding are limited by a high absorption of infrared radiation.

The limit of the simultaneous optimization of RF shielding performances, transparent in the visible and reflective (low-absorption) in the IR, is due to the different physical mechanism responsible for the shielding of electromagnetic radiation in three different frequency ranges of interest on the part of the metal/dielectric coating. In particular, while the range of the RF shielding mechanism is the reflection, in the range of IR in addition to reflection there is also a strong absorption due to the high IR absorption coefficient of metal layers, absorption that increases linearly with the total thickness of metal present in the structure, as long as each metal layer has a single thickness less than the penetration depth of electromagnetic radiation (skin depth) in this frequency range (IR). Typical skin depth values in the IR are in the order of several tens of nanometers (e.g. about 30 nm for silver at a wavelength of 1 μm). A high value of IR absorption in the case of coatings to be used for solar-control applications is highly dangerous because, in addition to limiting the reduction of solar heat in the environment that is desirable to shield, can cause damage due to overheating or thermal shock of the window (or transparent substrate) on which it is applied.

The present invention is different from previous inventions on similar topic as detailed in the following.

WO 99/15922 describes a frequency selective film having the structure of a Photonic Band Gap (PBG) device to transmit the electromagnetic radiation in a certain interval and to shield it in another range. The peculiarity of a PBG structure is the presence of a “periodic” arrangement of the single layer films stacked to build up the film. Such periodicity is responsible for the transmitting characteristics of the electromagnetic radiation (i.e. the transparency to a certain frequency range and the blocking of another range). The innovation of the present invention with respect to WO 99/15922 relays in the fact that if we compared two films, made according to WO 99/15922 and according to the present invention, by using the same materials and the same total metal thickness, it results that the film of the present invention is characterized by a lower total absorption of the solar radiation, a slightly better shielding of the infrared radiation, while keeping roughly the same transparency to the visible radiation and the same shielding effectiveness in the RF range. Such reduction of the solar absorption achieved with the film made according the present invention is principally due to the fact that the layer sequence in the present invention is not symmetric or periodic like in WO 99/15922, but the thicknesses of the metallic layer closer to the surface on which the solar radiation impinges is thicker than the other ones. Moreover, in WO 99/15922, the minimum number of metallic layers constituting the film is three, while in the present invention it is two with similar performances. Finally, in WO 99/15922, the first layer adjacent to the substrate is made of a metallic material, while in the present invention such layer is made of a dielectric material. A further difference between the present invention and the WO 99/15922 concerns the definition of shielding effectiveness. In the present invention the shielding effectiveness (SE) of the film is estimated as the ratio between the field amplitude in a point without and with the shield present, against an impinging plane wave with normal incidence, in the assumption that the shield is infinite. The SE of a film as defined above depends only on the electrical properties of the shield and on the total metal thickness, and it can be directly correlated with the value of the sheet resistance and of the effective conductivity of the material. Such definition of SE is not applied in WO 99/15922, and therefore the values of SE presented there are not representative of the actual properties of the film.

The invention U.S. Pat. No. 6,391,462B1 disclosures the general metal-dielectric structure on which all thin-film devices for low-emission and/or EM shielding applications are based. However, U.S. Pat. No. 6,391,462B1 does not provide any design specification in order to realize a film finalized to the minimization of the absorbance of the EM radiation in the IR in order to avoid any thermal shock of the substrate. In fact, the invention U.S. Pat. No. 6,391,462B1 is targeted to shield selectively the EM radiation produced by plasma displays instead of the EM solar radiation that is characterized by much higher thermal load and is the target of the present invention. Therefore, the innovation of the present invention with respect to U.S. Pat. No. 6,391,462B1 consists in the fact that this invention constraints the ratio between the thicknesses of the metallic layer as a function of their distance from the substrate in order to optimize and control the absorption properties in the IR. In particular, the present invention specifies exactly the value of the ratio between the thicknesses of the outermost to the innermost metallic layers, with a well defined small tolerance.

Another invention (U.S. Pat. No. 5,763,063) discloses a film in which each metal layer is over-coated by the sequence of two dielectric layers. Differently, in our invention each metal layer is over-coated by a single dielectric layer or by the sequence of a very thin metal layer and a dielectric layer. In the film of U.S. Pat. No. 5,763,063 the said dielectric layers over-coating each metal layer (i.e. “protecting” each metal layer) are composed substantially (i.e. for at least 90%) of dielectric selected from the group consisting of indium oxide, zinc oxide and mixed indium/zinc oxide (the first layer) or of mixed indium/tin oxide (the second layer). Differently, in our invention the dielectric layers are composed substantially of titanium oxide. It is also pointed out that the invention U.S. Pat. No. 5,763,063 concerns a method to improve corrosion resistance and durability of general coatings made of alternating sequences of metal and dielectric layers. Differently, our invention concerns a method to reduce the solar absorption of coatings made of alternating sequences of metal and dielectric layers, still keeping high transparency in the visible range.

The invention disclosed by US 2003/224182 consists in a system comprising at least two filters, the first one being a “yellow filter” having a light transmission below 450 nm of less than 50%, the second being either a light filter comprising a heat reflecting film and a metal, a light filter having IR transmission lower than 50% between 780 and 2500 nm, or a light filter comprising a multilayered stack having a sheet resistance of less than 4 ohms per square. The combination of filters is necessary to get the desired multifunctional performance, i.e. to attenuate the passage of selected wavelengths through the substrate as needed to address security risks. Differently, the present invention discloses a method to make a single filter, whose superior multifunctional performance cannot be achieved by simply combining the performance of single constituting parts, but it is inherent to the way in which the constituting parts are arranged together. Furthermore, it is not included in the present invention a “yellow filter” specifically addressed to attenuate UV radiation, because for the present application such a functionality is not of interest (i.e. the present invention is not intended for security purposes but just for energy efficiency and health/EMI protection). In the present invention the UV fraction of solar radiation that can be dangerous for health is efficiently shielded by the glass or polymeric substrate on which the film is applied in a typical embodiment, such as a glass window. Therefore this aspect is out of the scope of the present invention.

The invention disclosed by US 2009/130409 consists in providing that “the thickness of the smoothing layer of a less thick sub-adjacent coating cannot be greater than the thickness of the smoothing layer of a thicker sub-adjacent coating”, where such mentioned “smoothing layers” are not the functional metal layers responsible for IR and RF shielding of radiation. Differently, the present invention concerns with providing that the thickness of the functional metal layers responsible for IR and RF shielding of radiation fulfill the special requirement that the thickness of the metal functional layer closer to the surface on which the solar radiation impinges is thicker than the others metal functional layers embedded in the filter, according to a well defined proportion. This innovation is not contained in US 2009/130409, which describes examples in which all silver layers have the same thickness.

In EP 0990928 each silver (transparent electric conductor) film has a thickness in the range of from 5 to 20 nm. Differently, in the present invention: the thickness of the silver films is not fixed but it is different from one layer to the other, in particular being the thickness of the metal functional layer closer to the surface on which the solar radiation impinges thicker than the others metal functional layers embedded in the filter.

### OBJECT OF THE INVENTION

It is therefore a first object of the present invention the manufacturing of a multifunctional, frequency-selective shielding film, such that it results being shielding in the radiofrequencies and infrared, transparent in the visible and low-absorbent for solar radiation in the IR range, being characterized by having solar absorbance (Aₑ) always lower than 17% and one of the following combination of performances:

Shielding effectiveness (SE) higher than 32 dB from 30 kHz to 18 GHz, with optical visible transmittance (Tᵥ) higher than 75%;

Shielding effectiveness (SE) higher than 36 dB from 30 kHz to 18 GHz, with optical visible transmittance (Tᵥ) higher than 65%;

Shielding effectiveness (SE) higher than 38 dB from 30 kHz to 18 GHz, with optical visible transmittance (Tᵥ) higher than 50%.

It must be pointed out that the specified properties (i.e. Aₑ, SE and Tᵥ) are defined and measured according to the following definitions:

Aₑ is the direct solar absorbance, defined as the average absorbance (A(λ)) of solar radiation, weighted on the spectral energy distribution of the solar spectrum (S_{λ}) as defined in the ISO 9845 reference spectrum:

$${A}_{e} = \frac{{\sum }_{λ = 300 nm}^{2500 nm} {S}_{λ} A ( λ ) Δ λ}{{\sum }_{λ = 300 nm}^{2500 nm} {S}_{λ} Δ λ}$$

where Δλ is the wavelength step used for the calculation;

Tᵥ is defined as the average of the transmittance (T(λ)) weighted on human eye mean sensitivity curve (V(λ)) and the illuminant spectral energy distribution D65 (D_{λ}), in the 380-780 nm spectral range:

$${T}_{v} = \frac{{\sum }_{λ = 380 nm}^{780 nm} {D}_{λ} T ( λ ) V ( λ ) Δ λ}{{\sum }_{λ = 380 nm}^{780 nm} {D}_{λ} V ( λ ) Δ λ}$$

where Δλ is the wavelength step used for the calculation;

SE is the average shielding efficiency (SE(f)) in the frequency range between 30 KHz and 18 GHz of the stand-alone film for plain wave and normal incidence, according to the definition used in the standard ASTM 4935D-89:

$$SE ( f ) = 20 {log}_{10} ( \frac{{E}_{i} ( f )}{{E}_{t} ( f )} )$$

in which Eᵢ(f) and Eₜ(f) are the amplitudes of incident and transmitted electric fields through an electrically large-size panel made with the shielding material of the invention.

The aforementioned performances are representative of a real device, which includes barrier layers between the metallic and dielectric layers, having the effect of increasing Aₑ of about 5%, reducing Tᵥ of about 6%. Furthermore, both SE and Tᵥ are estimated using respectively the real measured electrical conductivity of a sputtered metal with thickness in the range of 10-30 nm and the real measured complex refractive index of the sputtered dielectric.

### SUMMARY OF THE INVENTION

These objects are achieved by means of a device according to at least one of the appended claims.

The device, object of the present invention, consists of an asymmetric metal/dielectric coating, containing two thin metal layers arranged in such a way that the thickness of the metal layer that is closer to surface on which the solar radiation impinges is thicker than the others metal functional layers embedded in the filter, being the ratio of the thicknesses of the thicker film to the thinner one in the range from 1.4 to 1.7.

The film of the invention can be applied on a transparent support such as a glass or a polymeric flexible film (hereinafter referred to as “substrate”), as shown in FIG. 1.

### LIST OF DRAWINGS

These and other advantages will be better understood by any person skilled in the art from the following description and the attached drawings, given as a non-limiting example, in which:

FIG. 1 shows a single-sided application pattern of the nanostructured film of the invention applied to a substrate S, e.g. a glass-window or a transparent film to be applied, in turn, on a window; the film F is applied on the face from solar radiation incidence side;

FIG. 2 shows the pattern of the film of the invention according to a particular embodiment described in Example 1;

FIG. 3 shows the plot of shielding efficiency (SE) of the screen described in Example 1, in which the thickness of the individual nanostructured film layers are reported in Table 1. The values of SE are obtained in the worse case hypothesis from measured values of the electrical conductivity of silver thin film having thickness of 17 nm, using the following well know expression:

SE(f)=45.51+20 log₁₀(σ_{Ag}_{_{—}}_{film}d_{Ag}_{ₜₒₜ})

in which σAg_film is the measured conductivity of the Ag film (7.75.106 S/m) and dAg_tot is the total thickness of Ad contained in the film (48 nm)—

(see M. S. Sarto, F. Sarto, M. C. Larciprete, M. Scalora, M. D'Amore, C. Sibilia, M. Bertolotti, “Nanotechnology of transparent metals for radio frequency electromagnetic shielding”, IEEE Trans. on EMC, November 2003, vol. 45, no. 4, pp. 586-594).

FIG. 4 shows the transmittance spectrum calculated in the optical range of the screen described in Example 1, in which the thickness of individual nanostructured film layers are reported in Table 1, compared with the reference curve resulting from the product between the human eye mean sensitivity curve and the illuminant energy distribution curve (D65);

FIG. 5 shows the calculated absorbance spectrum of the screen described in Example 1, in which the thickness of individual nanostructured film layers are reported in Table 1, in the range of wavelength where the solar spectrum is significant, compared with the reference curve relative to the ISO 9845 reference solar spectrum.

FIG. 6 shows the comparison between the absorbance and transmittance spectra of two different films having the same number and composition of layers as the film of Example 1, but different metallic layer thicknesses. In the one, corresponding to the present invention, the ratio between the thicknesses of the outermost to the innermost metallic layer is 1.67. In the other, representative to the state-of-art, the same ratio is 1. For both films the SE as defined above is 33.4 dB, and Tᵥ 75%.

FIG. 7 shows the comparison between the absorbance and transmittance spectra of two different films having the same number and composition of layers as the film of Example 1, but different metallic layer thicknesses. In the one, corresponding to present invention, the ratio between the thicknesses of the outermost to the innermost metallic layer is 1.55. In the other, representative to the state-of-art, the same ratio is 1. For both films the SE as defined above is 36.6 dB, and Tᵥ 66%.

FIG. 8 shows the comparison between the absorbance and transmittance spectra of two different films having the same number and composition of layers as the film of Example 1, but different metallic layer thicknesses. In the one, corresponding to the present invention, the ratio between the thicknesses of the outermost to the innermost metallic layer is 1.50. In the other, representative to the state-of-art, the same ratio is 1. For both films the SE as defined above is 38.9 dB, and Tᵥ 52%.

### DETAILED DESCRIPTION OF THE INVENTION

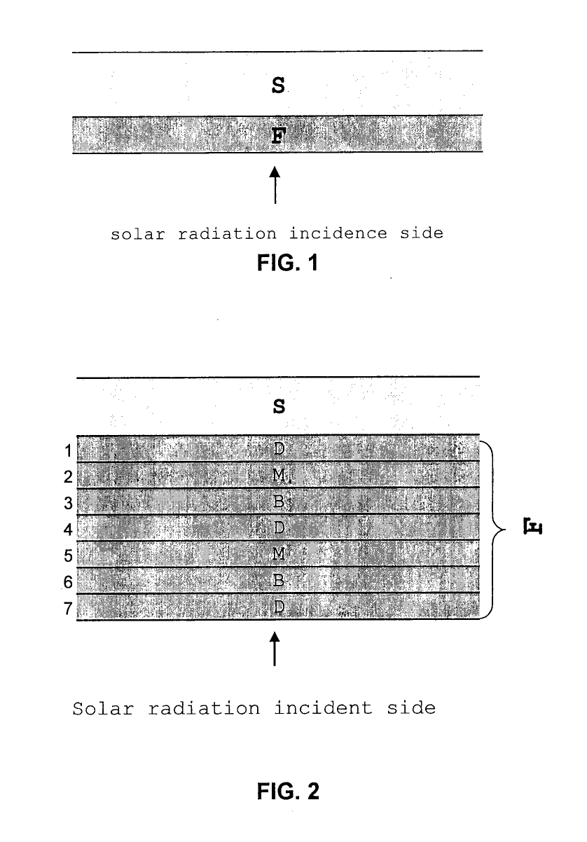

The present invention consists of a radiofrequency electromagnetic screen being low-absorbent for solar radiation and transparent in the visible, constituted by a multifunctional screening nanostructured film applied to a transparent substrate (referred to as “substrate”), according to the scheme reported in FIG. 1.

The substrate (indicated with “S” in FIG. 1), can be constituted by any transparent material, e.g. glass or polymer, in the form of a flexible sheet or film. In case of using polymer materials, those with high melting temperature and high work temperature, such as polycarbonate or polyester, are preferred, so that the screen does not degrade under solar thermal load and during the film deposition process. In case that the substrate is a sheet, it can be constituted by a single transparent material or a pair of transparent sheet containing gaseous insulation means therein, such as, for example, a double glass of a window.

In an exemplary and non-limiting embodiment of the present invention, the film F is constituted by a superposition of dielectrics or semiconductor D and metal M nanometric layers.

With reference to FIG. 1, in an exemplary embodiment, the film F can be applied on and coat one side of the substrate.

Dielectric nanometric layers D are preferably constituted by materials transparent in the visible and in the infrared, such as for example: TiO2, SiO2, Al2O3, Ta2O5, HfO2, SnO2, In2O3, MgF2, CaF2, BaF2, LaF3, AlF3, ZnO, ITO, Si3N4, GaN, ZnSe, DLC. Advantageously, in the described exemplary embodiment, the layers D are constituted by TiO2, which is particularly convenient due to its high refractive index and low extinction coefficient in the visible and near infrared spectrum.

The thickness of each dielectric layer is comprised between 10 nm and 300 nm, and is optimized to center the film transparency band in the visible and obtain the desired screen colour.

In one preferred embodiment, the metal layers M are separated from the subsequent dielectric layers D by an ultrathin barrier layer B, whose function is to inhibit the diffusion of silver or metal in the overlying layer.

Such barrier layer B can be made, for example, of Ti or Ni and have a preferable thickness of 1 nm, which can vary from 0.1 to 2 nm.

Metal layers M are constituted by a metal with high electrical conductivity, such as for example: Ag, Au, Cu, Al, Ni, Pd, Pt or alloys thereof. Advantageously, in the exemplary embodiment described, the metal layers have been selected from silver (Ag) in order to obtain a better transmission in the visible, inasmuch, in the optical range of wavelength incident on the screen, silver is characterized by a low value of the refractive index imaginary part and thus reducing the absorption by the screen.

According to the invention, the layers of the metal M have been selected in order to have a total thickness of metal sufficient to achieve a shielding efficiency (SE) against a plane wave with normal incidence, according to the definition appearing in the standard ASTM 4935D-89, in the band up to 18 GHz, preferably not less than 30 dB, but that can be changed between 20 dB and 100 dB, depending on the particular needs of the application. In a preferred embodiment of the invention the thickness of individual metal layers vary between 8 and 40 nm.

According to the invention, the thickness of metal layers constituting the film F is higher for the layers further away from the substrate (more “external”) and lower for the metal layers closer to the substrate (more “internal”), as described by way of example and not limitation of the present invention in Table 1 and FIG. 2 (with respect to Example 1). Such a configuration has the advantage of reducing the absorption within the film, amplified by multiple reflections at the interfaces between the metal and dielectric layers, especially in the area of the film where the solar thermal load is higher, i.e. the more external one. The result is that the film has a lower solar spectrum absorption factor, with the same total thickness of the metal used and therefore radio-frequency shielding efficiency.

### EXAMPLE 1

A particular embodiment of the invention consists of a multilayer nanostructured film constituted by the sequence of layers shown in Table 1, according to the scheme depicted in FIG. 2, deposited on a 6 mm thick glass substrate, according to the application pattern depicted in FIG. 1.

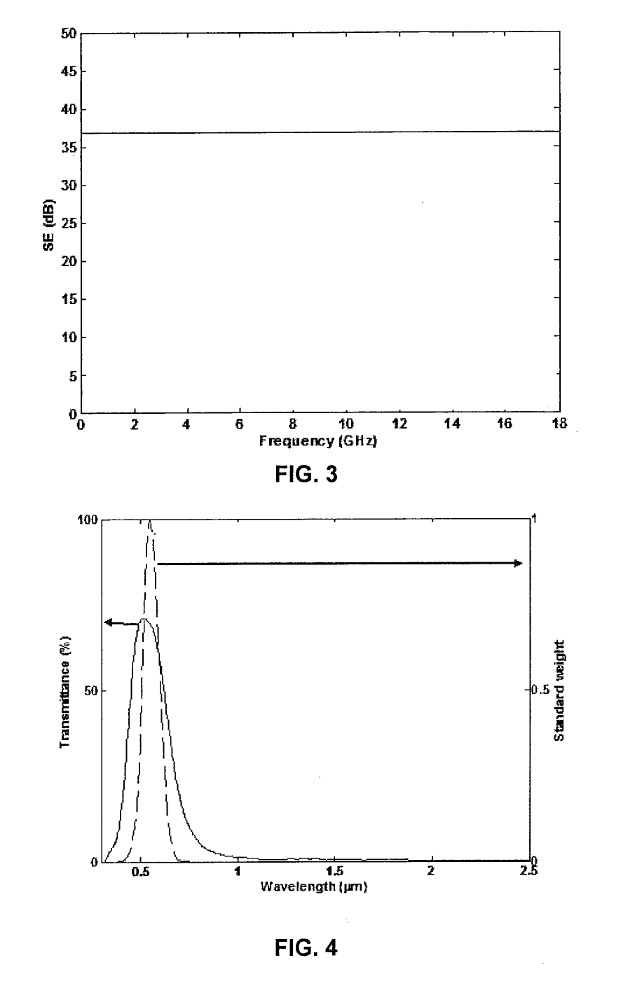

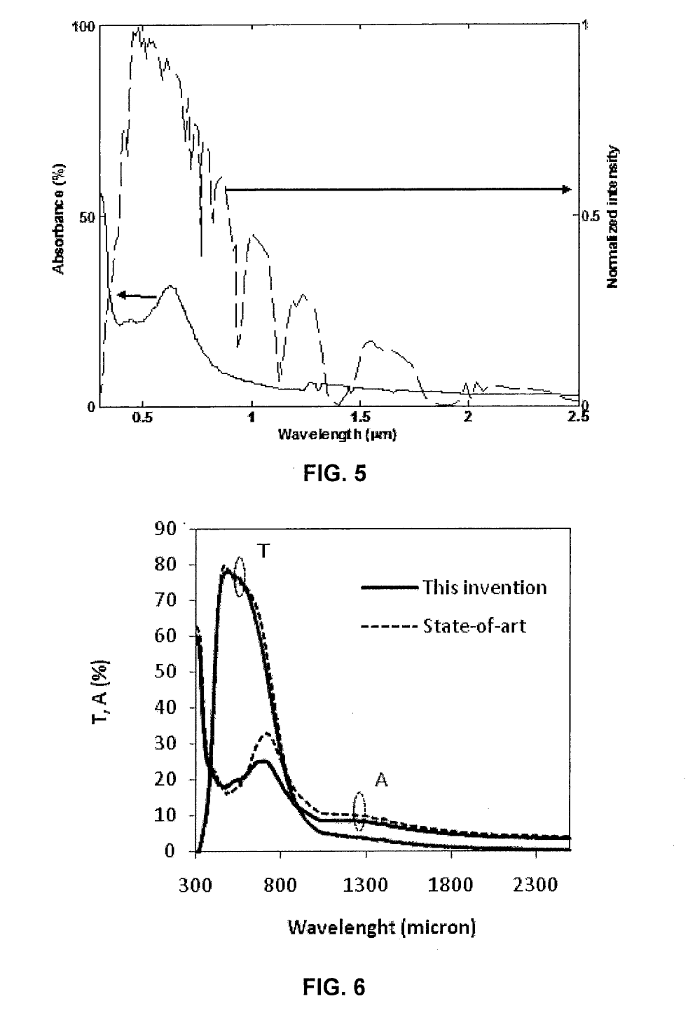

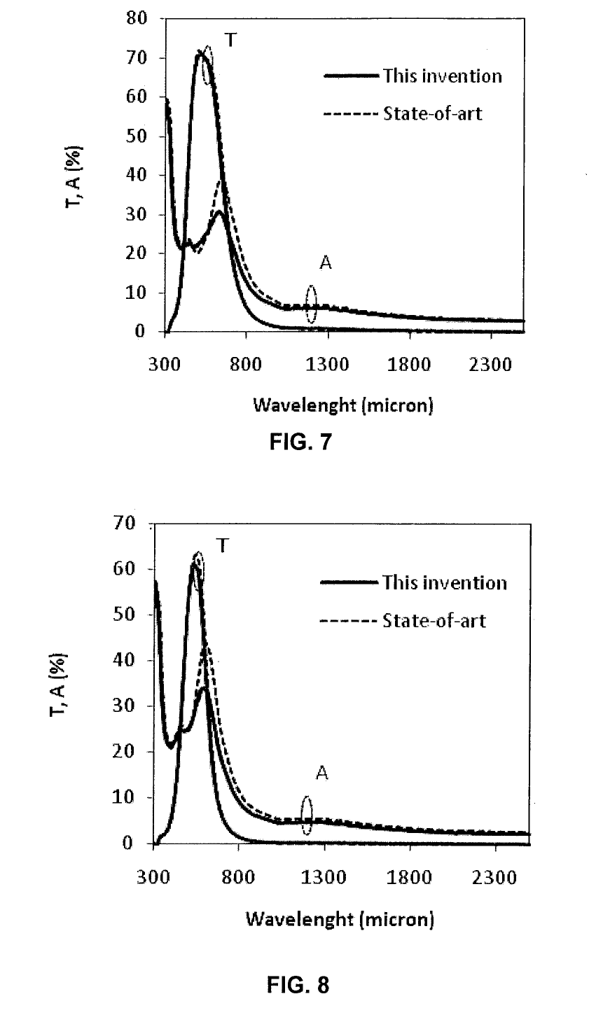

The expected performances of this screen are shown in FIGS. 3-4-5 regarding the electromagnetic shielding efficiency up to 18 GHz, the transmittance in the visible and the absorbance in the range where the solar spectrum is more significant, respectively.

Manufacturing Process

According to the invention, the screen object of the present invention was obtained by depositing the layers M, D, B on the substrate S by sputtering technique (ion beam sputtering, RF sputtering, magnetron sputtering, DC reactive sputtering) in order to control the thickness of each layer deposited.

In particular, it was found that for the manufacturing of the screen the optimal deposition system is the dual ion beam sputtering (DIBS), which allows to obtain excellent adhesion properties on plastic substrate, inasmuch it is capable of operating at low temperatures and of treating conveniently the substrate surface before film deposition. Film sputtering deposition systems (“web-coater”) can be used to manufacture the film of the invention when the substrate is a flexible film.

TABLE 1
Layer sequence of the film of Example 1.

| Layer | Material | Thickness (nm) | |
|---|---|---|---|
| Substrate | Glass | 6 | mm |
| 1 | TiO₂ | 31 | |
| 2 | Ag | 18 | |
| 3 | Ti | 0.5 | |
| 4 | TiO₂ | 63 | |
| 5 | Ag | 28 | |
| 6 | Ti | 0.5 | |
| 7 | TiO₂ | 30 | |

The invention has been described with reference to preferred embodiments, but it is understood that changes may be made in any case without departing from the scope of protection granted.

1. A multifunctional nanostructured thin film comprising a superposition of three dielectric or semiconductor nanometric layers (D) alternate with two metal layers (M), said film shielding radiofrequency electromagnetic radiation, being transparent in the visible, shielding infrared radiation, characterized in that the outermost metal layer, i.e., the one furthest from the substrate, is thicker than the innermost one, i.e., the one nearest to the substrate, being the ratio between the thickness of the outermost to the innermost in the range from 1.4 to 1.7; wherein said film is applied on a face of a transparent substrate on the side upon which the solar radiation impinges in order to obtain a frequency selective screen having solar absorbance (Aₑ) always lower than 17% and one of the following combination of performances:
Shielding effectiveness (SE) higher than 32 dB from 30 kHz to 18 GHz, with optical visible transmittance (Tᵥ) higher than 75%;
Shielding effectiveness higher (SE) than 36 dB from 30 kHz to 18 GHz, with optical visible transmittance (Tᵥ) higher than 65%;
Shielding effectiveness (SE) higher than 38 dB from 30 kHz to 18 GHz, with optical visible transmittance (Tᵥ) higher than 50%.

2. The nano-structured film according to claim 1, comprising a plurality of shielding layers whose superior multifunctional performance is not achieved by simply combining the performance of single constituting parts, but it is obtained by an asymmetric and aperiodic superposition with which the constituting parts are arranged together.

3. The film according to claim 1, wherein said dielectric nanometric layers (D) are constituted by materials transparent in the visible and in the infrared, such as for example: TiO2, SiO2, Al2O3, Ta2O5, HfO2, SnO2, In2O3, MgF2, CaF2, BaF2, LaF3, AlF3, ZnO, ITO, Si3N4, GaN, ZnSe, DLC.

4. The film according to claim 1, wherein said metal nanometric layers (M) are constituted by a metal with high electrical conductivity, such as for example:
Ag, Au, Cu, Al, Ni, Pd, Pt or alloys thereof.

5. The film according to claim 1, wherein said metal layers (M) are layers of silver.

6. The film according to claim 1, wherein said metal layers (M) are separated from the subsequent dielectric layers (D) by an ultrathin barrier layer (B).

7. The film according to claim 1, wherein said barrier layers (B) are made of Ti or Ni and have a thickness of between 0.1 nm and 2 nm.

8. A multifunctional electromagnetic shield comprising a plate-like substrate transparent in the visible (S) coated on one side with a film according to claim 1.

9. The multifunctional electromagnetic shield according to claim 1, wherein said substrate (S) is constituted by a flexible transparent film.

10. The multifunctional electromagnetic shield according to claim 1, wherein said substrate (S) is selected between a plate of glass or polymer and a pair of plates separated by a gaseous insulating medium.

11. The multifunctional electromagnetic shield according to claim 1, wherein said substrate (S) is selected between a plate of glass or polymer and a pair of plates separated by a gaseous insulating medium, on the faces of which a flexible transparent film is applied.
